(19) United States
(12) Patent Application Publication
(10) Pub. No.: US 2006/0251807 A1
(43) Pub. Date: Nov. 9, 2006

(54) Roofing Granules With Improved Surface Coating Coverage And Functionalities And Method For Producing Same

(76) Inventors: Keith C. Hong, Lititz, PA (US); Ming L. Shiao, Collegeville, PA (US)

Correspondence Address: PAUL AND PAUL, 2000 MARKET STREET, SUITE 2900, PHILADELPHIA, PA, 19103, US

(21) Appl. No.: 11/379,733

(22) Filed: Apr. 21, 2006

Related U.S. Application Data
(60) Provisional application No. 60/678,404, filed on May 6, 2005.

(51) Int. Cl. B05D 7/00

(52) U.S. Cl. 427/212

(57) ABSTRACT

Roofing granules are produced by suspending selected mineral particles in a selected medium to separate the individual particles, uniformly depositing a coating material, and curing the coating material.

### CROSS-REFERENCE TO RELATED APPLICATION

This is a non-provisional application claiming the priority of U.S. Provisional Patent Application No. 60/678,404 filed May 6, 2005.

### BACKGROUND OF THE INVENTION

1. Field of the Invention

The present invention relates to asphalt roofing shingles and membranes, and protective granules for such shingles, and processes for makings such granules and shingles.

2. Brief Description of the Prior Art

Roofing granules are generally used in asphalt shingles or in roofing membranes to protect asphalt from harmful UV radiation and to add aesthetic values to a roof. Typically, roofing granules are produced by using inert mineral particles that are colored by pigments, clay, and alkali metal silicate binders in the processes as described by the U.S. Pat. Nos. 2,981,636, 4,378,408, 5,411,803, or 5,723,516.

In these processes, roofing granules are typically produced by mixing mineral particles with the coating materials in a pan coater prior to drying or curing of the color coating. Such granules have limited surface coverage by the coating materials, or a “spotty” surface appearance due to the inability of the coating process to evenly deposit coating materials on the highly irregular surface of the mineral particles.

Oftentimes, it is observed in the cross section of roofing granules that the color coating is accumulated at the low point or the “valley” on the mineral surface and is absent on the high point or the “peak” of the surface. As a result of such limited surface coverage by these processes, the roofing granules are typically difficult to achieve high color saturation and intensity without the use of excessive coating materials or multi-layer coatings. Also, the current processes are incapable of coloring mineral particles that have flat or flaky shapes due to excessive agglomeration during the coloring stage.

Currently, the industry has been using multiple coating passes during the process to improve the surface coverage on the roofing granules by the coating materials. However, it is impossible to fully encapsulate the roofing granules using the current process. In addition, the surface coating coverage in some cases can only reach 70% even with multiple passes.

Thus, there is a need for an improved process for coating irregularly shaped roofing granules uniformly. In addition, there is a need for a process for coating roofing granules that makes efficient use of coating materials.

### SUMMARY OF THE INVENTION

The present invention advantageously provides a process for preparing fully encapsulated roofing granules. The present process advantageously permits improved encapsulation of time-released biocides for algae control. In addition, the present process advantageously provides roofing granules with improved optical properties. Furthermore, the present process advantageously provides improved resistance of roofing granules to staining and adhesion to bitumen substrate. In addition, the present process provides irregularly shaped roofing granules with one or more layers of uniform coatings. In addition, the present process makes efficient use of coating materials.

The process of the present invention for producing roofing granules having high coating coverage or coating encapsulation comprises (1) suspending selected base particles, such as mineral particles, in a first fluid medium to separate the individual particles; (2) uniformly depositing a coating material on the surface of the selected base particles; and (3) curing the coating material to form a coating on the surface of the individual particles to form coated particles.

In another embodiment of the present invention, the process preferably further comprises (4) suspending the coated particles in a second fluid medium to separate the individual coated particles, (5) uniformly dispersing a second coating material on the surface of the coated particles, and (6) curing the second coating material to form a second coating on the surface of the coated particles to form roofing granules. The second fluid medium can be the same as the first fluid medium, for example, both the first fluid medium and the second fluid medium can be air. The second fluid medium can also differ from the first fluid medium.

The base particles selected for use in the present invention are preferably selected from the group consisting of durable, inert inorganic mineral particles, roofing granules coated with a silicate coating, roofing granules coated with a silicate coating including at least one metal oxide colorant, roofing granules coated with a silicate coating including at least one solar reflective material, roofing granules coated with a silica coating, roofing granules coated with a phosphate coating, roofing granules coated with a titanate coating, roofing granules coated with a zirconate coating, roofing granules coating with an aluminate coating, and roofing granules coated with a silicate coating including at least one algaecide. Preferably, the base particles have a particle size between #8 and #50 U.S. mesh. Preferably, the base particles have good compressive strength.

Preferably, a uniform coating is deposited on the base particles by suspending the base particles in a fluid medium, and applying a coating material to the suspended base particles. Preferably, the base particles are suspended as a fluidized bed, and coating material is applied to the suspended base particles by spray application. Preferably, a Wurster fluidized bed spray device is employed to apply at least one coating material to the base particles.

In one embodiment of the present process, at least a first layer and a second layer are applied to the base particles in a fluidized bed spray device, the first layer including a first biocidal material, and the second layer containing a second biocidal material. In this embodiment the present process provides algae-resistant roofing granules with improved algae resistance.

In another embodiment of the present process, at least a first layer and a second layer are applied to the base particles in a fluidized bed spray device, the first layer including a solar heat reflective material, and the second layer including a colorant. In this embodiment, the present process provides roofing granules with improved solar heat reflectance.

In still another embodiment of the present process, a single layer is applied to the base particles in a fluidized bed spray device, the applied coating composition including both a solar heat reflective material, a colorant, or a colorant having solar heat-reflective properties. In this embodiment, the present process provides roofing granules with improved solar heat reflectance and good color intensity or saturation in a single process step.

Thus, in one aspect the present invention provides a process for producing roofing granules having high coating coverage or coating encapsulation. In this aspect the process comprises suspending selected base particles in a selected medium to separate the individual particles; uniformly depositing a first coating material on a surface of the selected mineral particles; and then curing the first coating material to form a first coating on the surface of the individual particles to form coated particles. In another aspect, the process of the present invention further comprises suspending the coated particles in a selected medium to separate the individual coated particles; uniformly depositing a second coating material on the surface of the coated mineral particles; and curing the second coating material to form a second coating on the surface of the coated particles to form roofing granules.

In yet another aspect, the process comprises suspending selected base particles in a selected medium to separate the individual particles; uniformly depositing a first coating material on the surface of the selected base particles; uniformly depositing a second coating material on the surface of the first coating material; and curing both the first coating material and the second coating material to form roofing granules.

Preferably, each coating layer applied by the process of the present invention has a thickness between from about 5 micrometers to 200 micrometers, and more preferably between from about 12.5 micrometers to 40 micrometers.

Preferably, the cured first coating layer covers at least about 75 percent of the surface of the base particle, and more preferably at least about 90 percent of the surface of the base particle. It is especially preferred that the cured first coating layer continuously cover the surface of the base particle, and that the cured first coating layer have a substantially uniform thickness.

Preferably, the cured second coating layer covers at least about 75 percent of the surface of the coated particle, and more preferably at least about 90 percent of the surface of the coated particle. It is especially preferred that the cured second coating layer continuously cover the surface of the coated particle, and that the cured second coating layer have a substantially uniform thickness.

In one embodiment of the present invention, the first coating material includes an organic polymeric coating binder, preferably an acrylic latex. In this embodiment the second coating material preferably includes a second organic polymeric binder, which can be the same binder as employed for the first coating material or a different binder.

In another embodiment of the present invention, the first coating material preferably includes an inorganic binder selected from the group consisting of silicate binders, titanate binders, zirconate binders, aluminate binders, phosphate binders, and silica binders.

In another embodiment of the present invention, the first coating material includes a first algaecidal composition, and preferably, the first coating material also includes an acrylic latex coating binder. In this embodiment the second coating material preferably includes a second algaecidal composition, and the second coating material also includes an acrylic latex coating binder, which can be the same binder as employed for the first coating material or a different binder.

In yet another embodiment of the present invention, the first coating material includes a solar-reflective material, preferably, titanium dioxide, and the second coating material preferably includes a colorant.

In another embodiment of the present invention, the second coating material includes a solar-reflective material, preferably, titanium dioxide.

In another embodiment of the present invention, the first coating material includes a colorant, and the second coating material includes another colorant or “optical effect” pigments to form granules with desired visual effects.

In another aspect, the present invention provides a process for providing conventional roofing granules with one or more substantially uniform exterior coating layers. The exterior coating layers can be formed from coating compositions including inorganic binders such as binders including sodium silicate or organic binders such as binders including acrylic polymer latex, and include functional materials such as algaecides and solar reflective pigments such as titanium dioxide.

The present invention also provides roofing granules produced according to the process of the present invention, and bituminous roofing products including roofing granules prepared according to the process of this invention.

### BRIEF DESCRIPTION OF THE DRAWINGS

FIG. 1 a polarized light micrograph of a prior art white-colored roofing granule (WA9300, 3M Company, Wausau, Wis.)

FIG. 2 is cross-sectional view of roofing granules prepared according to the process of the present invention.

FIG. 3 is a cross-sectional view of a prior art roofing granule of FIG. 1.

FIG. 4 is a bi-threshold method image analysis of micrograph of FIG. 1 shown superposed on the image of the prior art roofing granules of FIG. 1.

FIG. 5 is a polarized light micrograph of roofing granules prepared by the process of the present invention.

FIG. 6 is a bi-threshold method image analysis of micrograph of FIG. 5 shown superposed on the image of the roofing granules of FIG. 5.

FIG. 7 is a bar graph showing particle size distributions of mineral particles before and after coating the mineral particles with a process according to the present invention.

FIG. 8 is a cross-sectional view of a slate particle coated using a process according to the present invention.

FIG. 9 is a schematic elevational view of a Wurster spray-coating device being employed in a process according to the present invention.

FIG. 10 is an enlarged schematic elevational view of a portion of the Wurster spray-coating device of FIG. 9.

FIG. 11 is a schematic cross-sectional view of an algae-resistant roofing granule of the present invention having two coating layers.

FIG. 12 is a schematic graph of algaecidal or biocidal effectiveness as a function of time for the roofing granule of FIG. 11.

FIG. 13 is a polarized light micrograph of roofing granules prepared by the process of the present invention.

FIG. 14 is a graph comparing the quantity of copper leached from algae-resistant granule prepared according to the present invention with control algae-resistant granules as a function of time.

FIG. 15 is a polarized light micrograph of roofing granules prepared by the process of the present invention.

FIG. 16 is a polarized light micrograph of roofing granules prepared by the process of the present invention.

### DETAILED DESCRIPTION OF THE PREFERRED EMBODIMENTS

The present invention addresses the problems posed by prior art processes which do not make efficient use of coating material, often fail to completely cover the surface of the frequently highly irregular mineral particles of the type employed in preparing roofing granules, and fail to provide uniform surface coatings on mineral particles.

FIG. 1 is a polarized light micrograph of prior art commercially available roofing granules (WA9300, 3M Company, Wausau, Wis.). These prior art roofing granules are believed to have been coated using a conventional roof coating process. The micrograph shows that the roofing granules have a “patchy” appearance which reflects low coating coverage on the mineral particle surface, that is, a substantial portion of the mineral particle surface appears not to have been coated at all with the coating composition applied during manufacture of the roofing granules.

As used in the present specification, the strength in color space E* is defined as E*=(L^{*2}+a^{*2}+b^{*2})^{1/2}, where L*, a*, and b* are the color measurements for a given sample using the 1976 CIE L*a*b* color space. The total color difference ΔE* is defined as ΔE*=(ΔL^{*2}+Δa^{*2}+Δb^{*2})^{1/2} where ΔL*, Δa*, and Δb* are respectively the differences in L*, a* and b* for two different color measurements.

As used in the present specification, a coating having a “substantially uniform thickness” means that 90 percent of the surface area of the coating has a thickness that is within plus or minus 25 percent of the average thickness of the coating.

Examples of suitable mineral particles for use in the present invention include durable, inert inorganic particles with particle size between #8 to #50 US mesh and good compression strength to endure the coloring and shingle-making process. Examples of mineral particles that can be used in the process of the present invention also include roofing granules, such as granules treated or coated with materials to provide algae-resistance, and conventional roofing granules coated with silicate coating compositions including metal oxide colorants, metallic granules such as zinc granules, and the like. Examples of materials that can be employed to prepare algae-resistant granules for use as base particles in the present process include organic biocides such as carbamates, triazines, quaternary ammonium compounds, and the like, inorganic biocides such as cuprous oxide, zinc oxide, titanium oxide, and the like, and metals such as copper and zinc.

In one aspect, the base particles employed in the process of the present invention are preferably chemically inert materials, such as inert mineral particles. The mineral particles, which can be produced by a series of quarrying, crushing, and screening operations, are generally intermediate between sand and gravel in size (that is, between about 8 US mesh and 70 US mesh), and preferably have an average particle size of from about 0.2 mm to about 3 mm, and more preferably from about 0.4 mm to about 2.4 mm.

In particular, suitably sized particles of naturally occurring materials such as talc, slag, granite, silica sand, greenstone, andesite, porphyry, marble, syenite, rhyolite, diabase, greystone, quartz, slate, trap rock, basalt, and marine shells can be used, as well as recycled manufactured materials such as crushed bricks, concrete, porcelain, fire clay, and the like.

In one set of presently preferred embodiments, the base particles comprise particles having a generally plate-like geometry. Examples of generally plate-like particles include mica and flaky slate. Roofing granules having a generally plate-like geometry have been found to provide greater surface coverage when used to prepare bituminous roofing products, when compared with conventional “cubical” roofing granules, such as disclosed in commonly assigned U.S. Patent Publication No. 20050072114 A1, incorporated herein by reference.

In another aspect, the base particles are roofing granules prepared by conventional or known processes, such as roofing granules formed from inert mineral particles coated with a cured silicate coating layer including one or more metal oxide colorants.

Coating surface coverage is measured using image analysis software, namely, Image-Pro Plus from Media Cybernetics, Inc., Silver Spring, Md. 20910. The surface area is recorded in a black and white image using a CCD camera fitted to a microscope and illuminated with polarized light. The image is then separated into a coated portion and an uncoated portion using the bi-level threshold method in gray scale. The amount of coating coverage is then calculated by the image analysis software based upon the number of pixels with gray scale above the threshold level divided by the total number of pixels in the image.

Examples of suitable media for suspending the base particles to be coated include, but not limited to, air, water, or any suitable liquid or gas. The major function of medium is to suspend and separate individual granules so that they can be properly coated by the coating material to achieve uniform coverage.

The suspension medium can be moving, such as air in the fluidized bed process, or semi-stationary, such as in the spinning disc process. The suspension medium can be heated, cooled, or pH-controlled to facilitate the coating curing process. The suspension medium can also contain monomers (such as in the interfacial polymerization process) or catalyst (such as in the coacervation process) or reactive species (such as in the vapor permeation cure process) that facilitate the formation of coating material. The composition of the suspension medium can be adjusted over time during the process.

In the process of the present invention, one or more coating layers can be applied to the base particles. The suspension medium used for applying a specific coating layer can be the same as used in applying other coating layers. For example, air can be used to suspend the particles during each coating step in the present process. On the other hand, the suspension medium employed in a specific coating step can differ from the suspension medium employed in other steps. For example, air can be used as the suspension medium in an initial fluidized bed coating step, while nitrogen or another inert gas can be employed as the suspension medium in a second fluidized bed coating step. The suspension medium can be selected to facilitate the coating curing process, to reduce the extent of oxidation of the coating materials employed (for example, by employing nitrogen or another inert gas), or to otherwise facilitate desired chemical reactions in the coating materials. Suitable coating deposition methods comprise spraying in fluidized bed coating process, encapsulation in coacervation process, coating formation in interfacial polymerization process, and coating by the spinning disc coating process.

For example, the Wurster fluidized bed coating process can be employed. In the Wurster method, such as disclosed, for example in U.S. Pat. No. 2,799,241, U.S. Pat. No. 3,089,824, U.S. Pat. No. 3,117,024, U.S. Pat. No. 3,196,827, U.S. Pat. No. 3,207,824, U.S. Pat. No. 3,241,520, U.S. Pat. No. 3,253,944, and U.S. Pat. No. 4,623,588, the roofing granules are suspended in an upward stream of air, while liquid coating material is sprayed up into the suspended granules.

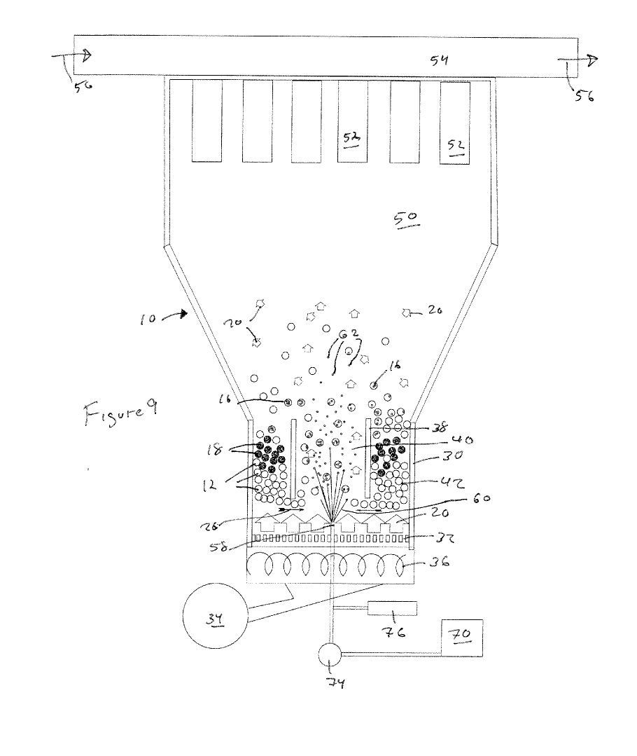

In a typical Wurster-type bottom spray coating device 10, as is schematically illustrated in FIG. 9, the particles 12 to be coated are suspended by a stream of fluid (signified by the arrows 20), typically air, entering a generally cylindrical particle chamber 30 from below through an air distribution plate 32. The size and configuration of the apertures in the air distribution plate 32 can be adapted to provide the air flow characteristics desired. FIG. 10 provides an enlarged view of the central portion of the coating device 10. The suspending or process air is provided by a suitable pump 34, or other source of high-pressure air (FIG. 9). The suspending air can be conditioned by suitable heating or cooling coils 36. The particle chamber 30 can be optionally partitioned by a generally cylindrical wall 38 (“Wurster cylinder”) into an inner chamber 40 and an outer chamber 42, with the bulk of the air stream being directed into the inner chamber 42, and just enough air being directed to the outer chamber 40 to maintain the particles in suspension as a fluidized bed. The force of the air stream into the inner chamber 42 propels the particles 12 upward into an upper chamber 50, until gravity and the lower pressure over the outer chamber 42 permit the particles to drop back into the top of the outer chamber 42. As particles are propelled up and out of the inner chamber 40, they are replaced at the bottom of the inner chamber 40 by particles passing under the wall or partition 38 separating the inner chamber 40 and the outer chamber 42, as shown schematically by the arrows 26. This creates a kind of continuous fountain of particles circulating in the coating device 10. A spray nozzle 58 is provided in the center of the air distribution plate 32 below the inner chamber 40, and coating material 60, supplied from a suitable reservoir 70 by a pump 74 and mixed with atomizing air provided from a suitable source 76, is atomized through the nozzle 58 into the chamber 40. The coating material droplets 62 tend to contact and deposit on the particles 12 rising out of the inner chamber 40 to provide particles partially coated with the coating material 16. When the coating material comprises a solution including a solvent such as water or an organic solvent, the solvent tends to evaporate from the solution of coating material deposited on the surface of the particles in the upper chamber 50, and the coating material can coalesce to form a continuous film on the particle surface to give coated particles 18. When the coating material is a non-solution type coating, such as a hot-melt coating material, the material droplets 62 on the surface of the particles tend to cool and solidify as the particles 12 are propelled into the upper chamber 50. Filters 52 are provided at the upper end of the upper chamber 50 as well as a source of suction 54 provided by an airflow (shown schematically by the arrows 56) to trap dust and to remove and recycle evaporated solvent from the device 10.

This type of coating device is preferably employed to provide a precise and uniform coating on the surface of the particles of the present invention. Multiple coating layers can be applied in a single batch by applying a sequence of coating materials to the particles through the spray nozzle 58.

Wurster-type fluidized bed spray devices are available from a number of vendors, including Glatt Air Techniques, Inc., Ramsey, N.J. 07446; Chungjin Tech. Co. Ltd., South Korea; Fluid Air Inc., Aurora, Ill. 60504, and Niro Inc., Columbia, Md. 21045.

The nature, extent, and thickness of the coating provided in a Wurster-type fluidized bed spray device depends upon a number of parameters including the residence time of the particles in the device, the particle shape, the particle size distribution, the temperature of the suspending airflow, the temperature of the fluidized bed of particles, the pressure of the suspending airflow, the pressure of the atomizing air, the composition of the coating material, the size of the droplets of coating material, the size of the droplets of coating material relative to the size of the particles to be coated, the spreadability of the droplets of coating material on the surface of the particles to be coated, the loading of the device with the mineral particles or batch size, the viscosity of the coating material, the physical dimensions of the device, and the spray rate.

Modified Wurster-type devices and processes, such as, the Wurster-type coating device disclosed in U.S. Patent Publication 20050069707 for improving the coating of asymmetric particles, can also be employed. In addition, lining the interior surface of the coating device with abrasion-resistant materials can be employed to extend the service life of the coater.

Other types of batch process particle fluidized bed spray coating techniques and devices can be used. For example, the particles can be suspended in a fluidized bed, and the coating material can be applied tangentially to the flow of the fluidized bed, as by use of a rotary device to impart motion to the coating material droplets.

In the alternative, other types of particle fluidized bed spray coatings can be employed. For example, the particles can be suspended as a fluidized bed, and coated by spray application of a coating material from above the fluidized bed. In another alternative, the particles can be suspended in a fluidized bed, and coated by spray application of a coating material from below the fluidized bed, such as is described in detail above. In either case, the coating material can be applied in either a batch process or a continuous process. In coating devices used in continuous processes, uncoated particles enter the fluidized bed and can travel through several zones, such as a preheating zone, a spray application zone, and a drying zone, before the coated particles exit the device. Further, the particles can travel through multiple zones in which different coating layers are applied as the particles travel thought the corresponding coating zones.

In the spinning disc method the granules and droplets of the liquid coating material are simultaneously released from the edge of a spinning disc, such as disclosed, of example, in U.S. Pat. No. 4,675,140.

Other processes suitable for depositing uniform coating on the granules will become apparent to those who are skilled in the art.

For example, magnetically assisted impaction coating (“MAIC”) available from Aveka Corp., Woodbury, Minn., can be used to coat granules with solid particles such as titanium dioxide. Other techniques for coating dry particles with dry materials can also be adapted for use in the present process, such as the use of a Mechanofusion device, available from Hosokawa Micron Corp., Osaka, JP; a Theta Composer device, available from Tokuj Corp., Hiratsuka, JP, and a Hybridzer device, available from Nara Machinery, Tokyo, JP.

Coating compositions employed by the present invention can include inorganic binders such as ceramic binders, and binders formed from silicates, silica, zirconates, titanates, phosphate compounds, et al. For example, the coating composition can include sodium silicate and kaolin clay.

Organic binders can also be employed in the process of the present invention. The use of suitable organic binders, when cured can also provide superior granule surface with enhanced granule adhesion to the asphalt substrate and with better staining resistance to asphaltic materials. Roofing granules including inorganic binders often require additional surface treatments to impart certain water repellency for granule adhesion and staining resistance. U.S. Pat. No. 5,240,760 discloses examples of polysiloxane-treated roofing granules that provide enhanced water repellency and staining resistance. With the organic binders, the additional surface treatments may be eliminated. Also, certain organic binders, particularly those water-based systems, can be cured by drying at much lower temperatures as compared to the inorganic binders such as metal-silicates, which often require curing at temperatures greater than about 500 degrees C. or by using a separate pickling process to render the coating durable.

Examples of organic binders that can be employed in the process of the present invention include acrylic polymers, alkyd and polyesters, amino resins, melamine resins, epoxy resins, phenolics, polyamides, polyurethanes, silicone resins, vinyl resins, polyols, cycloaliphatic epoxides, polysulfides, phenoxy, fluoropolymer resins. Examples of uv-curable organic binders that can be employed in the process of the present invention include uv-curable acrylates, uv-curable polyurethanes, uv-curable cycloaliphatic epoxides, and blends of these polymers. In addition, electron beam-curable polyurethanes, acrylates and other polymers can also be used as binders. High solids, film-forming, synthetic polymer latex binders are useful in the practice of the present invention. Presently preferred polymeric materials useful as binders include uv-resistant polymeric materials, such as poly(meth)acrylate materials, including poly methyl methacrylate, copolymers of methyl methacrylate and alkyl acrylates such as ethyl acrylate and butyl acrylate, and copolymers of acrylate and methacrylate monomers with other monomers, such as styrene. Preferably, the monomer composition of the copolymer is selected to provide a hard, durable coating. If desired, the monomer mixture can include functional monomers to provide desirable properties, such as crosslinkability to the copolymers. The organic material can be dispersed or dissolved in a suitable solvent, such as coatings solvents well known in the coatings arts, and the resulting solution used to coat the granules. Alternatively, water-borne emulsified organic materials, such as acrylate emulsion polymers, can be employed to coat the granules, and the water subsequently removed to allow the emulsified organic materials of the coating composition to coalesce. When a fluidized bed coating device is used to coat the inorganic particles, the coating composition can be a 100 percent solids, hot-melt composition including a synthetic organic polymer that is heated to melt the composition before spray application.

In one aspect of the present invention, at least two layers of coating composition are applied to the mineral particles. Such multiple layers can include individual layers having an inorganic binder, as well as individual layers having an organic binder. The binder can be the same or different in different layers. For example, in roofing granules having two coating layers, the first coating layer can comprise an inorganic binder such an alkali metal silicate and the second or outer coating layer can comprise an organic binder, such as an (meth)acrylic latex binder.

Preferably, each layer of coating composition has a thickness between from about 5 micrometers to 200 micrometers (0.2 mil to 8 mil), and more preferably between from about 12.5 micrometers to 40 micrometers.

In yet another aspect of the present invention, mineral particles are initially coated with an alkali metal silicate coating, using a conventional roof granule preparation method to provide initially coated particles. Subsequently, the initially coated particles are suspended in a selected medium to separate the individual initially coated particles, a coating material is uniformly depositing on the surface of the initially coated mineral particles; and the second coating material is cured to form a second coating on the surface of the individual initially coated particles. The second coating material can also be a silicate coating material.

Furthermore, one or more of these coating composition layers can contain one or more algaecides to render the coatings algaecidal. Examples of algaecides that can be employed include, but not limited to, organic algaecides such as carbamates, triazines, quaternary ammonium compounds, and the like, inorganic compounds such as cuprous oxide, zinc oxide, titanium oxide, and the like, and or metals such as copper and zinc. Photocatalytic particles such as titanium dioxide, zinc oxide, and the like can also be employed.

Similarly, specific coating layers can be adapted to provide other desired functional properties, such as algaecide leach rates, solar reflectance, thermochromic properties of the resulting granules, and the like.

One advantage of the new process disclosed herein is the ability to provide high coating coverage on the surface of roofing granules. This can provide roofing granules with various colors of high chromaticity that are otherwise not achievable by the traditional coloring method. Furthermore, the colors achieved by the new process will be less affected by the original colors of the mineral particles, which can vary greatly due to their difference in chemical composition, rock metamorphism, and impurities. As a result, the granules made by the new process can have better color consistency from source to source and from plant to plant.

Examples of pigments that can be included in the coating layers applied in the process of the present invention include pigments that provide optical effects.

Light-interference platelet pigments are known to give rise to various optical effects when incorporated in coatings, including opalescence or pearlescence. Surprisingly, light-interference platelet pigments have been found to provide or enhance infrared-reflectance of roofing granules coated with compositions including such pigments.

Examples of light-interference platelet pigments that can be employed in the process of the present invention include pigments available from Wenzhou Pearlescent Pigments Co., Ltd., No. 9 Small East District, Wenzhou Economical and Technical Development Zone, Peoples Republic of China, such as Taizhu TZ5013 (mica, rutile titanium dioxide and iron oxide, golden color), TZ5012 (mica, rutile titanium dioxide and iron oxide, golden color), TZ4013 (mica and iron oxide, wine red color), TZ4012 (mica and iron oxide, red brown color), TZ4011 (mica and iron oxide, bronze color), TZ2015 (mica and rutile titanium dioxide, interference green color), TZ2014 (mica and rutile titanium dioxide, interference blue color), TZ2013 (mica and rutile titanium dioxide, interference violet color), TZ2012 (mica and rutile titanium dioxide, interference red color), TZ2011 (mica and rutile titanium dioxide, interference golden color), TZ1222 (mica and rutile titanium dioxide, silver white color), TZ1004 (mica and anatase titanium dioxide, silver white color), TZ4001/600 (mica and iron oxide, bronze appearance), TZ5003/600 (mica, titanium oxide and iron oxide, gold appearance), TZ1001/80 (mica and titanium dioxide, off-white appearance), TZ2001/600 (mica, titanium dioxide, tin oxide, off-white/gold appearance), TZ2004/600 (mica, titanium dioxide, tin oxide, off-white/blue appearance), TZ2005/600 (mica, titanium dioxide, tin oxide, off-white/green appearance), and TZ4002/600 (mica and iron oxide, bronze appearance).

Examples of light-interference platelet pigments that can be employed in the process of the present invention also include pigments available from Merck KGaA, Darmstadt, Germany, such as Iriodin® pearlescent pigment based on mica covered with a thin layer of titanium dioxide and/or iron oxide; Xirallic™ high chroma crystal effect pigment based upon Al2O3 platelets coated with metal oxides, including Xirallic T60-10 WNT crystal silver, Xirallic T 60-20 WNT sunbeam gold, and Xirallic F 60-50 WNT fireside copper; ColorStream™ multi color effect pigments based on SiO2 platelets coated with metal oxides, including ColorStream F 20-00 WNT autumn mystery and ColorStream F 20-07 WNT viola fantasy; and ultra interference pigments based on TiO2 and mica.

Examples of mirrorized silica pigments that can be employed in the process of the present invention include pigments such as Chrom Brite™ CB4500, available from Bead Brite, 400 Oser Ave, Suite 600, Hauppauge, N.Y. 11788.

In one aspect of the process of the present invention, a single layer is applied to the mineral particles in a fluidized bed spray device. The applied coating composition in this case includes both a solar heat-reflective material and a colorant. The present process thus advantageously provides roofing granules with improved solar heat reflectance and good color intensity or saturation in a single process step.

In another aspect of the present invention, the composition of the coating material is changed during application of the coating material. For example, the coating material being applied can be a mixture of two different coating material streams, and the proportion of the first material to the coating material can be changed during application. Thus, a gradient of coating composition can be achieved on the surface of the coated particles, rather than providing discrete, identifiable coating composition layers.

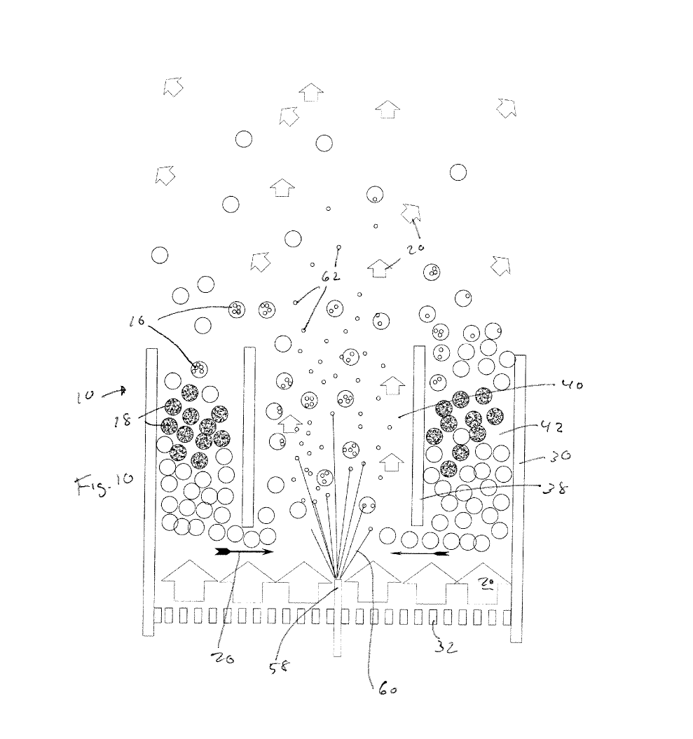

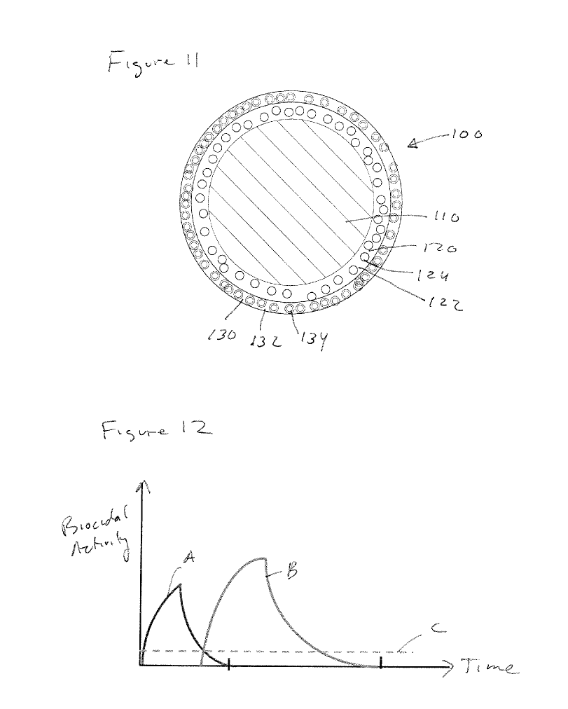

Another advantage of the new process disclosed herein is the capability to fully encapsulate the roofing granules with single or multiple layers of coating to provide specific functionality or performance. Examples of such granules include controlled-release algaecidal roofing granules, such that the granule has multiple coatings which will leach out algaecide at desirable time to alleviate the discoloration caused by algae, such as illustrated in FIGS. 11 and 12.

FIG. 11 is a schematic cross-sectional view of an algae-resistant roofing granule 100 prepared by the process of the present invention. The algae-resistant roofing granules 100 are prepared by coating mineral particles 110 using a Wurster-type spray coating device to provide a uniform first or inner coating layer 120 comprising a continuous coating film 122 formed, for example, of an acrylic latex copolymer, in which is suspended a first biocidal or algaecidal material 124. The algae-resistant roofing granules 100 also include a second or outer coating layer 130 comprising a continuous coating film 132, formed, for example, of an acrylic latex copolymer, in which is suspended a second biocidal or algaecidal material 134, the second or outer coating layer 130 also being applied using the Wurster-type spray device. The algae-resistant roofing granules 100 have algae resistance or biocidal activity that varies with time as shown schematically in the graph of FIG. 12. Initially, biocidal activity (shown as curve A in FIG. 12) is provided by the biocidal material 134 encapsulated in the outer layer 130 of the roofing granule 100, as the biocidal material 134 leaches out of the roofing granules 100. Subsequently, biocidal activity (shown as curve B in FIG. 12) is provided by the biocidal material 124 encapsulated in the inner layer 120 of the roofing granule, as the biocidal material 124 leaches out of the roofing granules 100. Preferably, factors that influence the leach rate and the activity of the biocidal materials, including the chemical composition of the respective biocidal material (e.g. nature of metal for metal oxides, oxidation state, nature of counterions, etc.), the physical form of the respective biocidal material (e.g. particle size, particle size distribution), the concentration of the biocidal material in the respective coating layer, the chemical composition and physical characteristics (e.g. porosity, film thickness) of the respective coating film, et al., are selected to provide sufficient biocidal activity to maintain the level of biocidal activity above the minimum level acceptable (shown as line C in FIG. 12) depending on the application in which the roofing granules 100 are employed.

Other examples of improved roofing granules provided by the process of the present invention are roofing granules with solar heat-reflective properties where roofing granules with single or multiple coatings that preferentially reflect the solar radiation in the near infrared range to reduce solar heat built-up (such as shown, for example, U.S. Patent Publication No. 20050072114 A1, incorporated herein by reference) or roofing granules with single or multiple coatings that provide enhanced adhesion to asphalt substrate, staining resistance, and dust reduction during granule transportation.

More examples of such roofing granules with specific functionality by using high surface coating coverage or complete encapsulation will become more apparent to those who are skilled in the art.

Yet another advantage is for coating particulates that are flat or have disc-like shapes, such as those that come from crushed slates, shale, or mica. Traditional coating methods are not capable of providing a sufficient surface coating partly due to agglomeration of particles during coating process. With a fluidized bed coating or comparable methods, excellent surface coating of these flaky particulates can be achieved without agglomeration problem.

Also, the disclosed coating process is applicable to other particulates used in exterior building products that require a high degree of surface coating coverage or encapsulation. Examples include the application of coating to lightweight aggregate for stucco to improve its compressive strength or to impart algae-resistant function for controlled release effects.

The improved roofing granules prepared according to the process of the present invention can be employed in the manufacture of roofing products, such as roofing shingles, using conventional roofing production processes. Typically, bituminous roofing products are sheet goods that include a non-woven base or scrim formed of a fibrous material, such as a glass fiber scrim. The base is coated with one or more layers of a bituminous material such as asphalt to provide water and weather resistance to the roofing product. One side of the roofing product is typically coated with mineral granules to provide durability, reflect heat and solar radiation, and to protect the bituminous binder from environmental degradation. The improved roofing granules of the present invention can be mixed with conventional roofing granules, and the granule mixture can be embedded in the surface of such bituminous roofing products using conventional methods. Alternatively, the improved roofing granules of the present invention can be substituted for conventional roofing granules in manufacture of bituminous roofing products to provide those roofing products with improved properties.

Bituminous roofing products are typically manufactured in continuous processes in which a continuous substrate sheet of a fibrous material such as a continuous felt sheet or glass fiber mat is immersed in a bath of hot, fluid bituminous coating material so that the bituminous material saturates the substrate sheet and coats at least one side of the substrate. The reverse side of the substrate sheet can be coated with an anti-stick material such as a suitable mineral powder or a fine sand. Alternatively, the reverse side of the substrate sheet can be coated with an adhesive material, such as a layer of a suitable bituminous material, to render the sheet self-adhering. In this case the adhesive layer is preferably covered with a suitable release sheet.

Roofing granules are then distributed over selected portions of the top of the sheet, and the bituminous material serves as an adhesive to bind the roofing granules to the sheet when the bituminous material has cooled.

Optionally, the sheet can then be cut into conventional shingle sizes and shapes (such as one foot by three feet rectangles), slots can be cut in the shingles to provide a plurality of “tabs” for ease of installation, additional bituminous adhesive can be applied in strategic locations and covered with release paper to provide for securing successive courses of shingles during roof installation, and the finished shingles can be packaged. More complex methods of shingle construction can also be employed, such as building up multiple layers of sheet in selected portions of the shingle to provide an enhanced visual appearance, or to simulate other types of roofing products.

In addition, the roofing membrane can be formed into roll goods for commercial or industrial roofing applications.

Examples of suitable bituminous membranes for use in the process of the present invention include asphalt roofing membranes such as asphalt-based, self-adhering roofing base sheet available from CertainTeed Corporation, Valley Forge, Pa., for example, WinterGuard™ shingle underlayment, a base sheet which is impregnated with rubberized asphalt.

Preferably, the reinforcement material comprises a non-woven web of fibers. Preferably, the nonwoven web comprises fibers selected from the group of glass fibers, polymeric fibers and combinations thereof. Examples of suitable reinforcement material for use as a tie-layer include, but not limited to, non-woven glass fiber mats, non-woven polyester mats, composite non-woven mats of various fibers, composite woven fabrics of various fibers, industrial fabrics such as papermaker's forming fabrics and papermaker's canvasses, polymer netting, screen, and mineral particles. The fibers employed in preparing the reinforcing material can be spun, blown or formed by other processes known in the art. Yarn for forming the reinforcement material can include mono-filament yarn, multi-filament yarn, spun yarn, processed yarn, textured yarn, bulked yarn, stretched yarn, crimped yarn, chenille yarn, and combinations thereof. The cross-section of the yarn employed can be circular, oval, rectangular, square, or star-shaped. The yarn can be solid, or hollow. The yarn can be formed from natural fibers such as wool and cotton; synthetic materials such as polyester, nylon, polypropylene, polyvinylidene fluoride, ethylene tetrafluroethylene copolymer, polyethylene terephthalate, polybutylene terephthalate, polytrimethylene terephthalate, poly(meth)acrylates, aramide, polyetherketone, polyethylene naphthalate, and the like, as well as non-organic materials such as spun glass fibers and metallic materials, or combinations thereof.

Non-woven glass fiber mats for use in the process of the present invention preferably have a weight per unit area of from about 40 to 150 g/m², more preferably form about 70 to 120 g/m², and still more preferably from about 80 to 100 g/m², and a thickness of from about 0.01 to 1 mm. Non-woven glass mats having a weight per unit area of about 90 g/m² (0.018 lb/ft²) are typically employed.

The bituminous material used in manufacturing roofing products according to the present invention is derived from a petroleum-processing by-product such as pitch, “straight-run” bitumen, or “blown” bitumen. The bituminous material can be modified with extender materials such as oils, petroleum extracts, and/or petroleum residues. The bituminous material can include various modifying ingredients such as polymeric materials, such as SBS (styrene-butadiene-styrene) block copolymers, resins, oils, flame-retardant materials, oils, stabilizing materials, anti-static compounds, and the like. Preferably, the total amount by weight of such modifying ingredients is not more than about 15 percent of the total weight of the bituminous material. The bituminous material can also include amorphous polyolefins, up to about 25 percent by weight. Examples of suitable amorphous polyolefins include atactic polypropylene, ethylene-propylene rubber, etc. Preferably, the amorphous polyolefins employed have a softening point of from about 130 degrees C. to about 160 degrees C. The bituminous composition can also include a suitable filler, such as calcium carbonate, talc, carbon black, stone dust, or fly ash, preferably in an amount from about 10 percent to 70 percent by weight of the bituminous composite material.

The following examples are provided to better disclose and teach processes and compositions of the present invention. They are for illustrative purposes only, and it must be acknowledged that minor variations and changes can be made without materially affecting the spirit and scope of the invention as recited in the claims that follow.

### EXAMPLE 1

Roofing base granules (1 kg) with particle size between #10 and #40 U.S. mesh (commercially available from CertainTeed Corp, Piedmont, Mo.) were coated using air as suspending medium and 142 g of 100% white acrylic latex coating (PZ4600, 57 wt % solid from Pratt & Lambert, Cleveland, Ohio) diluted with 5% water in a fluidized bed coating process. The base granules were suspended in the air heated at 120 degrees C. and moved at a speed of 33 cubic feet per minute. The coating was deposited onto the granule surface by a spraying tip at the bottom of the fluidized bed chamber with a spraying pressure of 18 psi and pump rate of 7 gal/minute. The duration of coating deposition was about 1.5 minutes. The resultant granules had a very uniform coating appearance and white color appearance with L*=80.44, a*=1.2. b*=1.47 when measured by Hunter Lab colorimeter, as compared to the typical white roofing granules shown in FIG. 1 with Hunter Lab color reading of L*=63.49, a*=0.45, and b*=1.49.

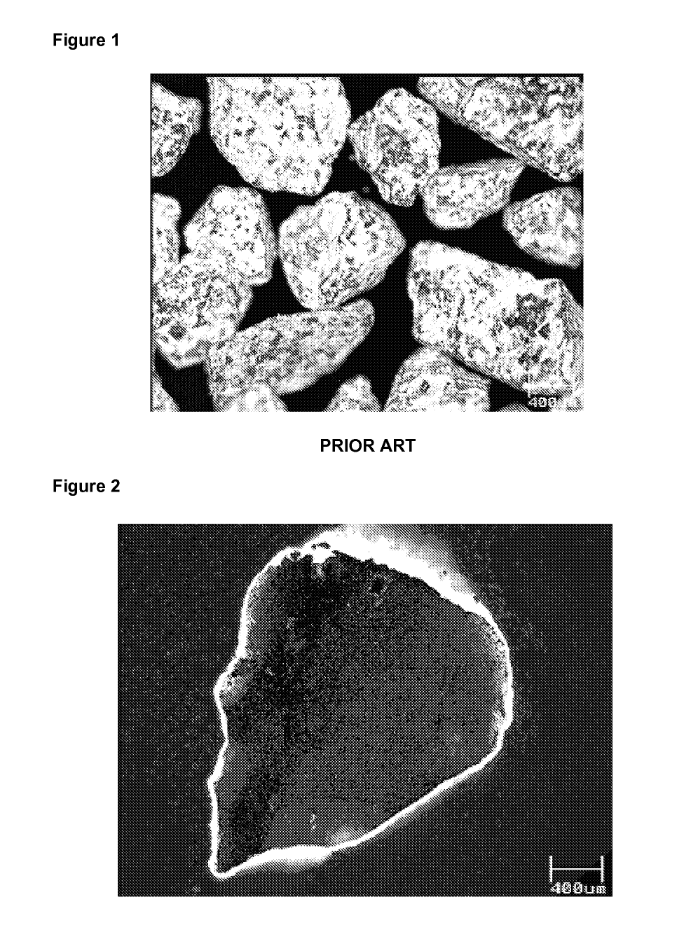

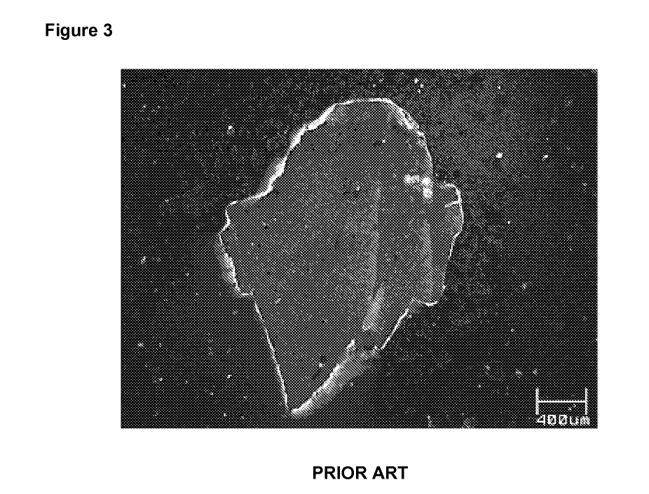

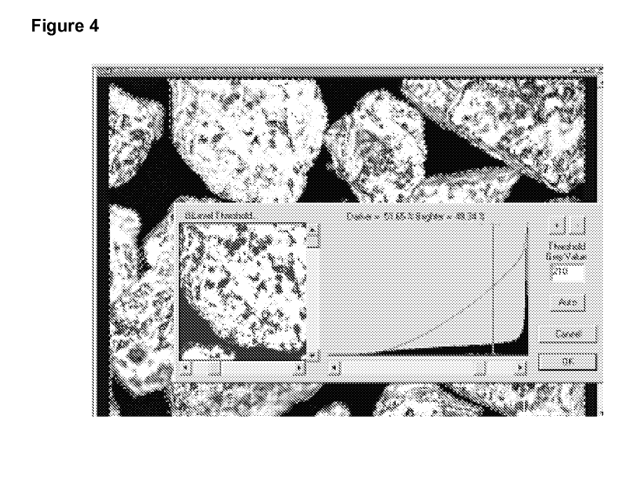

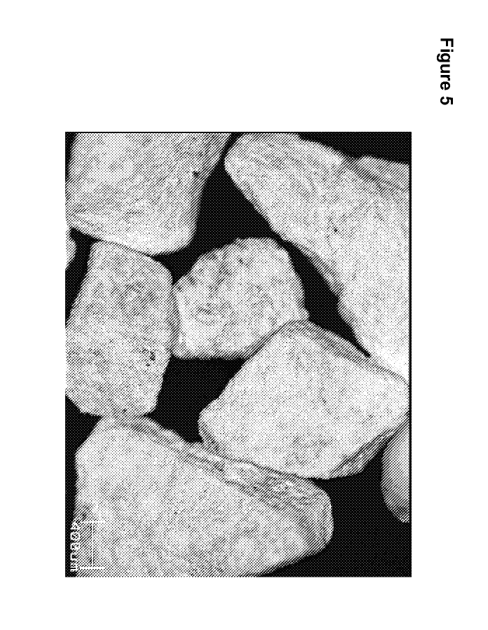

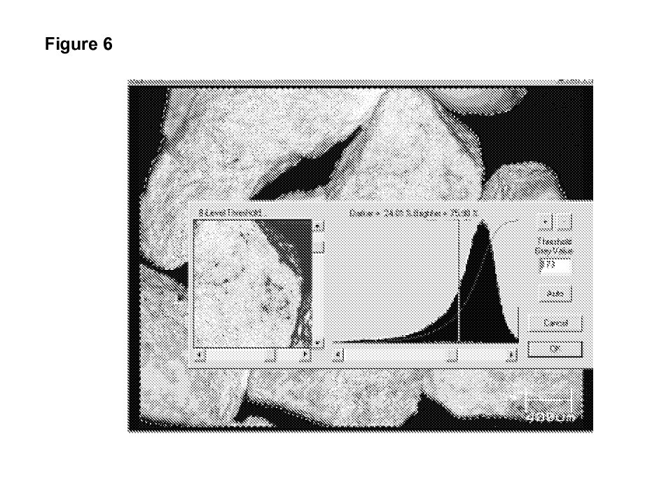

The cross section of the resultant granules show very uniform coating over the base granules, as shown in FIG. 2, as compared to a typical white roofing granule (#93 white from 3M Company, Wausau, Wis.) made by traditional roofing granule manufacturing (FIG. 3), where the coating is not uniform and only partly covers the surface. When viewed under polarized light microscope, the granules made by the traditional process (FIG. 1) have very limited surface coating coverage of about less than 50% as measured by the image analysis using the bi-level threshold method, as shown in FIG. 4. On the other hand, the resultant granules from the new process using the fluidize bed coating method have a high degree of surface coating coverage (FIG. 5) and the mineral surface is at least 75% covered as measured by the image analysis of the bi-level threshold method (FIG. 6).

### EXAMPLE 2

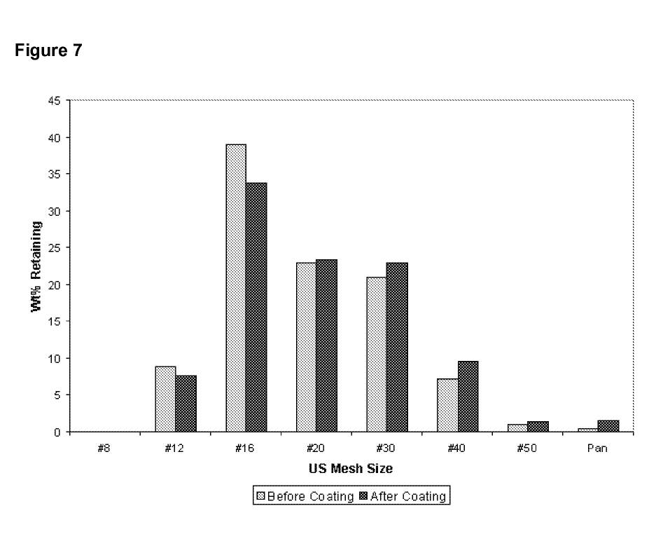

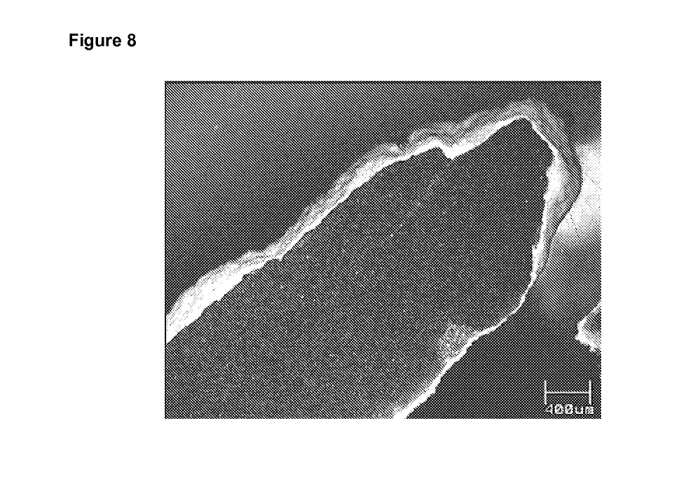

Mineral particles with a flake-like shape were coated by using air as suspending medium in a fluidized bed coating process. The coating process of Example 1 was repeated, except that about 890 gm of crushed slate granules with particle size ranging from #10 to #50 US mesh (H15 slate granules commercially available from Carrieres des Lacs, Saint-Aubin-des-Landes, France) were coated with 175 gm of the 100% acrylic latex in a fluidized bed coater. The resultant granules had an excellent white appearance with L*=76.86, a*=−1.61, and b*=−1.85 as measured by Hunter Lab calorimeter (as compared with L*=63.49, a*=0.45, and b*=1.49 of the typical white roofing granules shown in FIG. 1). A sieve analysis conducted on the slate granules before and after the coating process showed no increase in particle size, indicating no agglomeration due to the coating process (FIG. 7). In addition, as shown in the micrograph of FIG. 8, the cross section of the resultant coated granules revealed a uniform coating on their surface.

### EXAMPLE 3

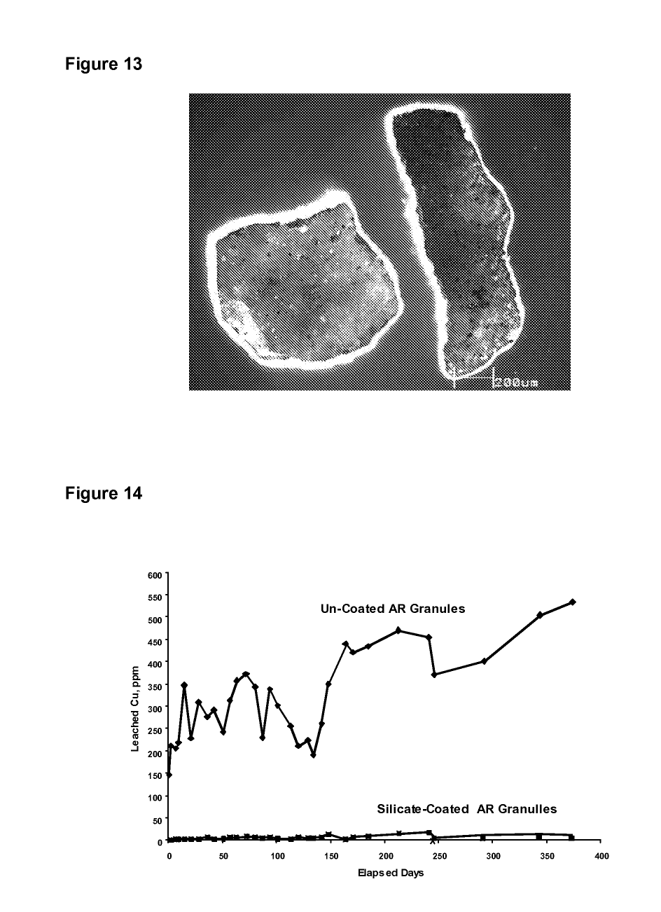

Algae-resistant (AR) roofing granules manufactured by CertainTeed Corporation (Piedmont, Mo.) had a particle size range between #10 and #40 U.S. mesh and contained nominally 6% by weight of cuprous oxide were coated with a silicate solution. The AR granules (600 g) were loaded into a fluidized bed coater and suspended in warm air (80 degrees C.) inside the coater with air flow of 33 scfm. A white silicate binder solution was introduced into the coater under a pressure of 18 psi and pump rate of 10 gal/min, and atomized into tiny droplets which in turn were deposited onto the granule surfaces. The white silicate binder had a solids content of 35% by weight and consisted of sodium silicate, ball clay, white titanium oxide pigment and water. After 20 minutes, the AR granules were encapsulated with a uniform silicate layer which accounted for 15.8% by weight of the final AR granules. FIG. 13 depicts two AR granules fully encapsulated by an outer layer of silicate binder.

To simulate accelerated leaching conditions, the encapsulated granules were immersed in a warm acidic solution (50 degrees C. and pH 5), and the amount of copper ion that was leached out daily from the inner AR granules were monitored for one year. A spectrophotometer supplied by the Hach Company (Model DR 2010) was used. The detection method was based on measuring at 560 nm the intensity of a reddish purple compound formed between copper ion and the dipotassium 2-2′-bicinchoninate reagent. FIG. 14 shows the concentration of copper ion, in ppm, as a function of elapsed days. The original uncoated AR granules were included as a control. Compared to the control, the detectable copper ion that were leached out from the encapsulated AR granules is very low, less than 1%, under the accelerated leaching condition described earlier.

### EXAMPLE 4

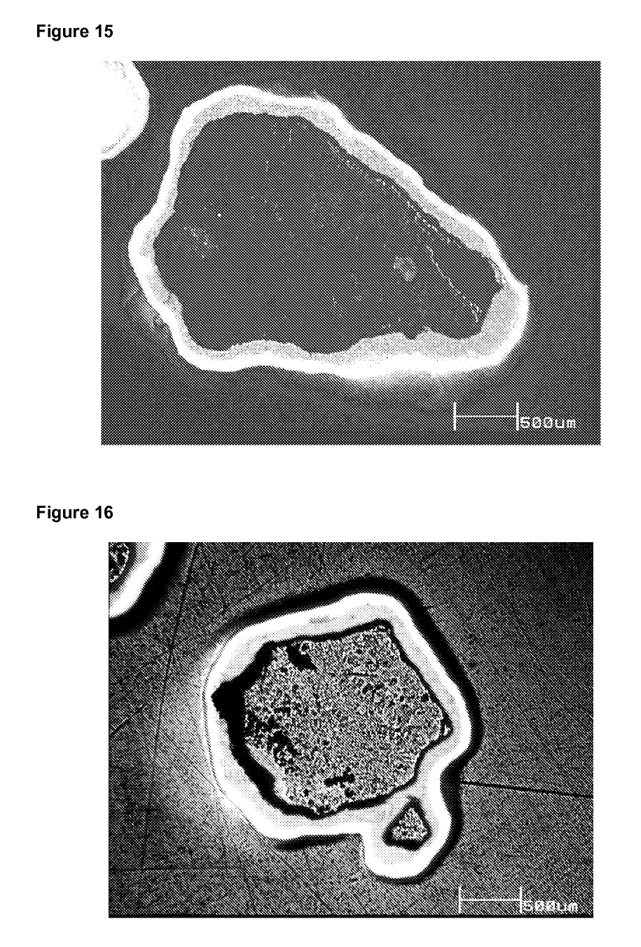

600 g of AR roofing granules (CertainTeed Corporation, Piedmont, Mo.) were fluidized in warm air under the conditions as in Example 3, except that the air temperature was reduced to 50 degrees C. For the first layer, the coating solution is a blue acrylic flat house paint available from a local Ace Hardware store, and was pumped into the coater at a rate of 5 gal/min. After 50 minutes and a weight gain of 14.7%, a uniform coating of blue acrylic fully encapsulated the core AR granules. Subsequently, a second coating solution of Ace white acrylic flat house paint was used to coat these blue AR granules. The processing time was 50 minutes and the added coating weight was 16.8%. The resulted composite granules consisted of an inner core made of AR granules and two outer layers of acrylics, with the inner layer being a blue coating and the outer layer a white coating. FIGS. 15 and 16 are micrographs of the cross section of the composite granules showing full encapsulation of the inner core granules.

### EXAMPLE 5

800 g of white roofing granules were prepared by coating mineral particles having sizes between US mesh #10 and US mesh #40 with a white coating composition composed of 65 g sodium silicate (OxyChem grade 42), 31.3 g TiO₂ (R101 from DuPont), 36 g of kaolin clay slurry (Royale slurry from Unimin Corp.), and 26 g of water. The coating composition was deposited on the mineral particles using a Wurster fluidized bed coater (Glatt model GPCG-1) under the airflow of 110 m³/hr and air temperature of 85 degrees C. (185 degrees F.). The coating process was continued until a dry coating weight of 4.8% was achieved. The white, coated granules were then cured in a rotary dryer at a temperature of 496 degrees C. (925 degrees F.). The resultant granules had a color measured by Hunter Lab Colorimeter (model Labscan XE) as L*=74.94, a*=−0.28, and b*=0.59; and a solar reflectance of 40.1% determined by the ASTM C-1549 method.

### COMPARATIVE EXAMPLE 1

The process of Example 5 was repeated, except that the white roofing granules were then prepared by using a conventional, non-fluidized bed coloring method using the same amount of coating formulation but mixing with the mineral particles in a tumbler until a uniform color coverage on granules was achieved. The granules were then heat cured in a rotary dryer. The resultant white granules have only color reading of L*=67.5, a*=0.27, and b*=1.26; and the solar reflectance of 32%.

These results show that the fluidized bed coating method can achieve higher pigment efficiency and hence higher solar reflectance than conventional coating methods. For a given level of coating and pigment applied to the granule, a higher level of coloration of the coated granule was obtained. This also shows that for a given desired level of coloration, the granule coated with the fluidized bed coating method of the invention could provide such coloration while employing lesser volumes of costly pigments.

Various other modifications can be made in the details of the various embodiments of the apparatus, compositions, and methods of the present invention, all within the scope and spirit of the invention and defined by the appended claims.

1. A process for producing roofing granules having high coating coverage or coating encapsulation, the process comprising:
(a) suspending selected base particles in a first fluid medium to separate the individual particles;
(b) uniformly depositing a first coating material on the surface of the selected base particles; and
(c) curing the first coating material to form a first coating on the surface of the individual particles to form coated particles.

2. The process of claim 1 further comprising:
(d) suspending the coated particles in a second fluid medium to separate the individual coated particles;
(e) uniformly depositing a second coating material on the surface of the coated particles; and
(f) curing the second coating material to form a second coating on the surface of the coated particles to form roofing granules.

3. A process according to claim 1 wherein the base particles are selected from the group consisting of durable, inert inorganic mineral particles, roofing granules coated with a silicate coating, roofing granules coated with a silicate coating including at least one metal oxide colorant, roofing granules coated with a silicate coating including at least one solar reflective material, and roofing granules coated with a silicate coating including at least one algaecide.

4. A process according to claim 1 wherein the base particles have a particle size between #8 and #50 U.S. mesh.

5. A process according to claim 1 wherein the first fluid medium is air.

6. A process according to claim 1 wherein the first coating material includes a first algaecidal composition.

7. A process according to claim 1 wherein the first coating material includes an organic polymeric coating binder.

8. A process according to claim 7 wherein the organic polymeric coating binder is an acrylic latex.

9. A process according to claim 1 wherein the first coating material includes an inorganic binder selected from the group consisting of silicate binders, titanate binders, zirconate binders, aluminate binders, and phosphate binders, silica binders.

10. A process according to claim 1 wherein the first coating has a thickness of from about 5 micrometers to 200 micrometers.

11. A process according to claim 2 where the second fluid medium is the same as the first fluid medium.

12. A process according to claim 2 wherein at least one of the first and the second coating materials includes a first algaecidal composition.

13. A process according to claim 2 wherein the second coating material includes an organic polymeric coating binder.

14. A process according to claim 13 wherein the organic polymeric material is an acrylic latex.

15. A process according to claim 2 wherein the second coating has a thickness of from about 5 micrometers to 200 micrometers.

16. A process according to claim 1 wherein the first coating material includes a solar-reflective material.

17. A process according to claim 2 wherein the second coating material includes a solar-reflective material.

18. A process according to claim 16 wherein the solar-reflective material comprises titanium dioxide.

19. A process according to claim 2 wherein the second coating material includes a colorant.

20. A process according to claim 1 wherein the first coating material includes a colorant.

21. Roofing granules produced according to the process of claim 1.

22. A bituminous roofing product including roofing granules according to claim 21.

23. Roofing granules produced according to the process of claim 2.

24. A bituminous roofing product including roofing granules according to claim 23.

25. A process for producing roofing granules having high coating coverage or coating encapsulation, the process comprising:
(a) suspending selected base particles in a fluid medium to separate the individual particles;
(b) uniformly depositing a first coating material on the surface of the selected base particles;
(c) uniformly depositing a second coating material on the surface of the first coating material; and
(d) curing the first coating material and the second coating material to form roofing granules.

26. A process according to claim 25 wherein the base particles are selected from the group consisting of durable, inert inorganic mineral particles, roofing granules coated with a silicate coating, roofing granules coated with a silicate coating including at least one metal oxide colorant, roofing granules coated with a silicate coating including at least one solar reflective material, and roofing granules coated with a silicate coating including at least one algaecide.

27. Roofing granules produced according to the process of claim 26.

28. A bituminous roofing product including roofing granules according to claim 27.
